(19) United States
(12) Patent Application Publication
(10) Pub. No.: US 2014/0321633 A1
(43) Pub. Date: Oct. 30, 2014

(54) PRIORITIZATION AND TIME ALLOCATION BY CUSTOMER SERVICE AGENTS

(71) Applicant: AVAYA INC., Basking Ridge, NJ (US)

(72) Inventors: George Erhart, Loveland, CO (US); Valentine C. Matula, Granville, OH (US); David Skiba, Golden, CO (US)

(73) Assignee: Avaya Inc., Basking Ridge, NJ (US)

(21) Appl. No.: 13/872,563

(22) Filed: Apr. 29, 2013

(51) Int. Cl. G06Q 10/06; H04M 3/51

(52) U.S. Cl. CPC G06Q 10/063118; H04M 3/5175
USPC 379/265.02

(57) ABSTRACT

A prioritization and time allocation by customer service is provided, whereby the customer service agents are incentivized to accept those tasks which more closely align with the objectives of a call center. Individual agents will then be able to pursue their own methodology to achieve their own goals and, in the process, pursue an objective of the contact center.

### FIELD OF THE DISCLOSURE

The present disclosure is generally directed toward systems and methods for improving customer service agent productivity. More particularly, incentivizing customer service agents to perform those tasks more closely associated with the contact center's objectives.

### BACKGROUND

Contact centers employ a number of agents to work at one or more on-site contact center facilities, off-site, or a combination of both. In many contact centers, the agents are presented with tasks and must choose which task deserves their attention at any given time.

Agents may select one task from multiple candidate tasks. Their selection of a particular task or tasks is substantially based on personal preference and expertise. However, the contact center employing the agent may see the priority of the tasks differently.

### SUMMARY

Certain advantages may be realized and the state of the art advanced by the methods and systems provided herein whereby contact center objectives are mapped into an easy to understand set of rules (e.g., game rules) that can be leveraged to assist the agent in focusing their attention on appropriate tasks at the appropriate time.

In one embodiment, a contact center identifies a number of objectives. Objectives are broadly embodied as acts, performance metrics, or other aspect of contact center operation. The achievement of which is influenced, at least in part, by the acts of one or more agents. Objectives may resemble business goals of the contact center or target a specific customer, type of customer, agent work policy or other function of the contact center. Objectives may be simplistic, such as, “provide good customer service.” In other embodiments, the objectives are more detailed or relate to more complex subject matter such as human resource issues, agent workload or key performance indicators (“KPIs”).

In another embodiment, a number of rules are mapped to one or more of the objectives. Rules are variously embodied and generally comprise at least one description or indicia of a task to be performed by an agent. Rules may also describe the quality or other performance metric associated with one or more tasks or other rules. Examples include, “answer a call within 15 seconds,” “achieve 95% customer satisfaction,” “respond to ‘silver’ level emails within one day,” or any one or more of the nearly limitless acts or metrics associated with an agent's activities associated with the contact center.

In another embodiment, point values are associated with at least one rule. Point values may be uniform, such as to function as a tally, or non-uniform, such as to provide a relative weight to a rule. The choice of specific point values or point value functions are selected such that the rules are aligned with the objectives of the contact center. In one embodiment, the weighting may be provided to the rules such that the relative importance is identified with respect to other rules. As an example, a first rule is three times as important as a second rule and the associated point value of the first rule is therefore three times that of the second rule. In other embodiments, the weighting reflects the level of expertise, effort or resources required. As an example, a first rule, associated with tasks which require twice as much time to complete as compared to tasks associated with a second rule, are weighted twice as much as the second rule.

While contact center objectives may be complementary, other objectives may conflict. Certain objectives may even conflict with themselves. For example, an objective to promptly answer all incoming phone calls may not be achieved during times of high contact center activity. As for which objective, or individual rule or task associated with an objective, is met may be determined, at least in part, by the agent. As an example, one objective may be associated with agents accepting a certain number of telephone calls, while another objective is associated with the agent asking the caller about their knowledge of additional goods or services that may be available. As a result, agents are conflicted between closing calls quickly and processing calls thoroughly. While agents may strive to comply with both objectives, such compliance may not be possible. As for which objective is achieved, or more fully achieved, the agent may be the determining factor. As taught herein, providing agents with tasks and their associated point values may direct the agent to select the task this is both more advantageous to them and more in line with the contact center's objectives. As will be discussed below, the relative point value of tasks associated with a particular rule or objective may be dynamic.

In embodiments where an agent may be assigned to handle more than one task simultaneously (e.g., non-real-time contacts), the agent may then utilize the point value associated with a task to assist them in selecting a particular task to perform.

As can be appreciated, agents are incentivized to earn points. Additional incentives may be available to agents earning more points, as compared to other agents, timeframes or threshold values. Different agents may approach this challenge differently. For example, one agent may determine the most advantageous strategy is to accept a greater number of low point value tasks. A second agent's strategy may be to accept a smaller number of high point value tasks. Still another agent may have a particular skill or preference and determine the most advantageous strategy is to accept tasks associated with a particular subject matter. And still another agent may choose a variety of tasks. By implementing the teachings herein, agents may then self-tailor a strategy they determine as most likely to maximize their points, while at the same time, perform those tasks more closely aligned with the objectives of the contact center.

The strategy selected by an agent may be substantially static or highly dynamic. Strategies may change based on an agent's own determination of how best to maximize points or changes in the point value associated with one or more tasks. In one embodiment, point values associated with one or more rules are changed in response to changing objectives of the contact center or to better align the rules with current contact center objectives. As an example, a contact center may have a new objective to provide a higher level of service for certain calls. As a result, the rules may or may not change, but the point values associated with the rules may be changed to reflect the updated priority of the calls. Objectives may also remain constant while the point value associated with rules changes. As one example, the objective of a call center may be to answer calls promptly and an associated rule being “answer incoming calls within 30 seconds.” However, another objective of the call center may be to thoroughly process each call. At times of low contact center activity, the point value associated with a thoroughness tasks may be increased and/or the point value associated with a tasks related to promptness—decreased. As contact center activity increases, the relative point values of the rules may be changed such that tasks associated with completeness are discounted relative to tasks related to promptness. As a result, agents may be provided with an intelligent interface operable to assist the agent in prioritizing their tasks. As a further benefit, tasks that are initially a low priority may have an associated rule that automatically elevates the point value, thereby preventing the task from being continually pushed aside in favor of higher-point tasks.

Additionally, rules may have an associated negative point value. For example, points may be lost due rules associated with the consumption of resources (e.g., time), performing a task poorly, and/or performing an undesired tasks (e.g., signing onto a work terminal after a specified start time). In a further embodiment, rules may be associated with tasks that occur substantially outside of the agent's control (i.e., “events”). One event is the passage of a certain amount of time. As a benefit of the teachings herein, rules and associated point values, in accord with the contact center's objectives, may be associated with events in a manner similar to tasks for which the agent has greater influence.

As further benefit of the teachings herein, agents may be presented with a game-like interface whereby tasks are performed to earn points. Scores and scoring opportunities may be presented to the agents, such as to communicate in real-time the point value associated with a task or set of tasks. As a result of implementing embodiments provided herein, an intelligent interface for assisting an agent to prioritize their completion of tasks is provided, thereby aligning the agent's behavior with the contact center's objectives and the agent's own abilities and preferences.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, a hard disk, a magnetic tape, or any other magnetic medium, magneto-optical medium, a CD-ROM, any other optical medium, punch cards, paper tape, any other physical medium with patterns of holes, a RAM, a PROM, an EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later developed hardware, software, firmware, artificial intelligence, fuzzy logic, or combination of hardware and software that is capable of performing the functionality associated with that element.

The term “contact center customer” generally refers to a business, charity, individual or other organization that has retained the services of the contact center for purposes of making or receiving inquiry or sales calls, providing or seeking information or other activity generally known by those of ordinary skill in the art to be a contact center activity. Additionally, a contact center customer may employ the resources directly whereby the contact center customer is substantially synonymous with the contact center.

The term “contact” is broadly defined and generally refers to one or more persons contacting, or being contacted, by the contact center, such as to seek information, strengthen the contact relationship, make a purchase or provide information to facilitate future sales and marketing activities, or any other party generally known by those of ordinary skill in the art as being a contact.

The term “agent” refers to employees, contractors and other types or groups of workers performing work for, or on behalf of, the contact center such as sales agents, customer service agents, or any other party generally known by those of ordinary skill in the art as being an agent.

It shall be understood that the term “means” as used herein shall be given its broadest possible interpretation in accordance with 35 U.S.C. §112(6). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Also, while the disclosure is described in terms of exemplary embodiments, it should be appreciated that individual aspects of the disclosure can be separately claimed. The present disclosure will be further understood from the drawings and the following detailed description. Although this description sets forth specific details, it is understood that certain embodiments of the disclosure may be practiced without these specific details. It is also understood that in some instances, well-known circuits, components and techniques have not been shown in detail in order to avoid obscuring the understanding of the invention

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The present disclosure is described in conjunction with the appended figures:

FIG. 1 is a diagram illustrating certain elements of a contact center implementing a prioritization methodology in accordance with embodiments of the present disclosure;

FIG. 2 illustrates high-level process for the generation of rules with associated point values in accordance with embodiments of the present disclosure;

FIG. 3 is a diagram illustrating the mapping of one set of contact center objectives to a number of rules in accordance with embodiments of the present disclosure;

FIG. 4 is a table illustrating a set of rules in accordance with embodiments of the present disclosure;

FIG. 5 is a diagram illustrating a second set of contact center objectives mapped to rules in accordance with embodiments of the present disclosure; and

FIG. 6 is a flowchart illustrating one method of operating a prioritization of contact center tasks in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments, it being understood that various changes may be made in the function and arrangement of elements without departing from the spirit and scope of the appended claims.

For the sake of simplicity, the embodiments herein are directed toward tasks whereby earning points is desired, and credited, and losing points is undesired, and debited. Generally, points are earned for performing tasks or performing tasks positively and points are lost for performing tasks poorly, not at all or by performing certain tasks associated with undesired behavior (e.g., being late). However, it should be apparent that other mathematical variations exist to provide a similar result. For example, earning fewer points may be used in place of decrementing an agent's points. As another example, similar to scoring in golf, is provided by lower scores winning over higher scores and penalties are increments to the player's score. In still another embodiment, negative and positive points are added to separate point categories. Scores may be compartmentalized whereby certain scores are combined with other, but not all, scores. In such an embodiment, an agent may have a certain number of points associated with two or more categories of points. Certain categories may have specific behaviors, such as a “bonus” category whereby points are only credited and not debited. These and other scoring methodologies may be incorporated without departing from the teachings herein.

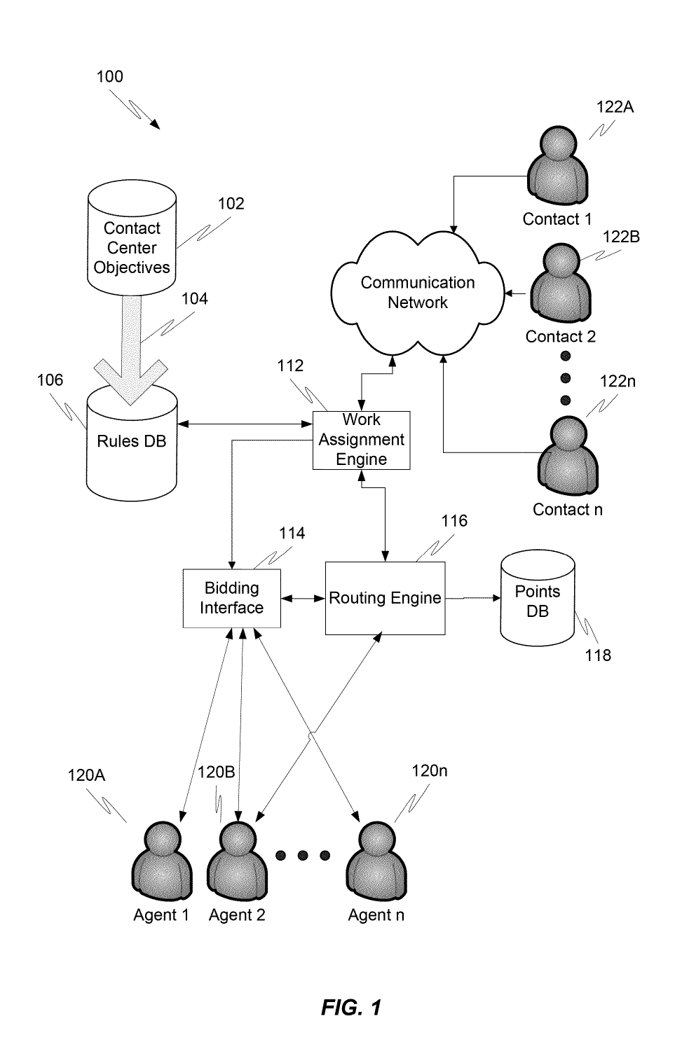

With respect to FIG. 1, diagram is illustrated with certain elements of a contact center 100 implementing a prioritization methodology in accordance with embodiments of the present disclosure. Database 102 contains a number of contact center objectives. Contact center objectives of database 102 are mapped 104 to rules in rules database 106. As is known in the art of databases, other configurations of databases 102 and 106, as well as mapping 104, may be implemented without departing from the teachings herein. As one alternative embodiment, databases 102 and 106 are records of one database wherein mapping 104 sets a field value of one of the records.

Contacts 122 contact the contact center via communications network 108. Communications network 108 may utilize a number of channel types (e.g., voice, in-person, text, email, or video) for multiple simultaneous sessions with contacts 122. In one embodiment, contact 122B, utilizing communications network 108, initiates contact with contact center 100.

In accordance with at least some embodiments of the present disclosure, the communication network 108 may comprise any type of known communication medium or collection of communication media and may use any type of protocols to transport messages between endpoints. The communication network 108 may include wired and/or wireless communication technologies. The Internet is an example of the communication network 108 that constitutes an Internet Protocol (IP) network consisting of many computers, computing networks, and other communication devices located all over the world, which are connected through many telephone systems and other means. Other examples of the communication network 108 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular network, and any other type of packet-switched or circuit-switched network known in the art. In addition, it can be appreciated that the communication network 108 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 108 may comprise a number of different communication media such as coaxial cable, copper cable/wire, fiber-optic cable, antennas for transmitting/receiving wireless messages, and combinations thereof.

Work assignment engine 112 creates at least one task associated with one of contacts 122, such as contact 122B. Work assignment engine may work in real-time to process incoming telephonic calls or retrieve messages, such as emails and text messages from repository. Work assignment engine 112 and rules database 106 determine the rules that will apply to the specific task and the associated point value. Work assignment engine 112 includes functionality to route contacts to human resources, such as agents 120, utilizing communication devices (e.g., a computer, telephone, laptop, etc.). Work assignment engine 112 may also include functionality to route contacts to automated resources (e.g., Interactive Voice Response (IVR) units, processors, servers, or the like) or any other resource known to be used in contact centers.

Work assignment engine 112 may utilize routing engine 116 to assign the specific task to one of agents 120, such as agent 120B. Work assignment engine 112 may present the task to bidding interface 114, whereby the task becomes visible to at least one of agents 120. Work assignment engine may concurrently operate any number of task assignment algorithms. One such algorithm precludes agents from accepting, or even becoming aware of, tasks that are beyond their qualifications.

In the embodiment illustrated, work assignment engine associates work tasks to rules from rules database 106. The association of a particular task with one or more rules may be performed by a computer program or programs running on the work assignment engine 112, as illustrated, or any other systems or component operable to associate a rule with a task.

In one embodiment, a task is associated with a rule and presented to routing engine 116 for presentation to one agent 120B. One agent 120B performs the task whereby routine engine 116 causes points database 118 to credit agent 120B with the points associated with the task's rules.

In a second embodiment, a task is associated with a rule and presented to routing engine 116 for presentation to more than one agent 120. One of the agents 120 performs the task whereby routine engine 116 causes points database 118 to credit the one of the agents 120 with the points associated with the task's rules.

In a third embodiment, a task is associated with a rule and presented to bidding interface 114. Agents 120 are then made aware of the task and afforded the opportunity to obtain the task. In one example, agent 120B wins the bid. The process of winning a bid is variously embodied. Generally, agents 120, in an effort to maximize points, wish to obtain tasks for the greatest number of points. However, agent 120B is competing with one or more other agents, (e.g., agent 120A and agents 120C (not shown) through 120n). Agents 120 may or may not be presented with an opening bid or the bid value at any given time. In another embodiment, agents 120 bid with points not associated with the points earned performing tasks, whereby a separate pool of bidding points is maintained independently of the agent's earned points. Contact center 100 may set additional bidding rules, such as time until bidding closes, initial bids, bidding increment value and the like. As a further embodiment, tasks for which receive no bids or no bid meeting minimum bidding requirements may be assigned to one of agents 120 by routing engine 116 or work assignment engine 112 via another algorithm or resubmitted to bidding interface 114. Such a resubmission to bidding interface 114 may cause the task to be subject to a rule of rules database 106, to increase the associated point value of the task.

In the embodiment illustrated, the winning bidder is agent 120B who is assigned the task and provides services to contact 122B. Routing engine 116 monitors the performance of the task and, if the task is performed and subject to any other rules, awards points to agent 120B in accord with the winning bid.

Points earned by agents 120 are maintained in points database 118. As can be appreciated by those of ordinary skill in the art, points database 118 may be combined with another database, accumulated in a memory or media, tallied or other means operable to credit agents 120 for points earned and, optionally, debit points for points lost, penalized or consumed. In some embodiments, routing engine 116 best able to determine whether or not a task is complete and points should be credited. In other embodiments a separate rules engine may be implemented to calculate and/or credit points according to the rules of rules database 106.

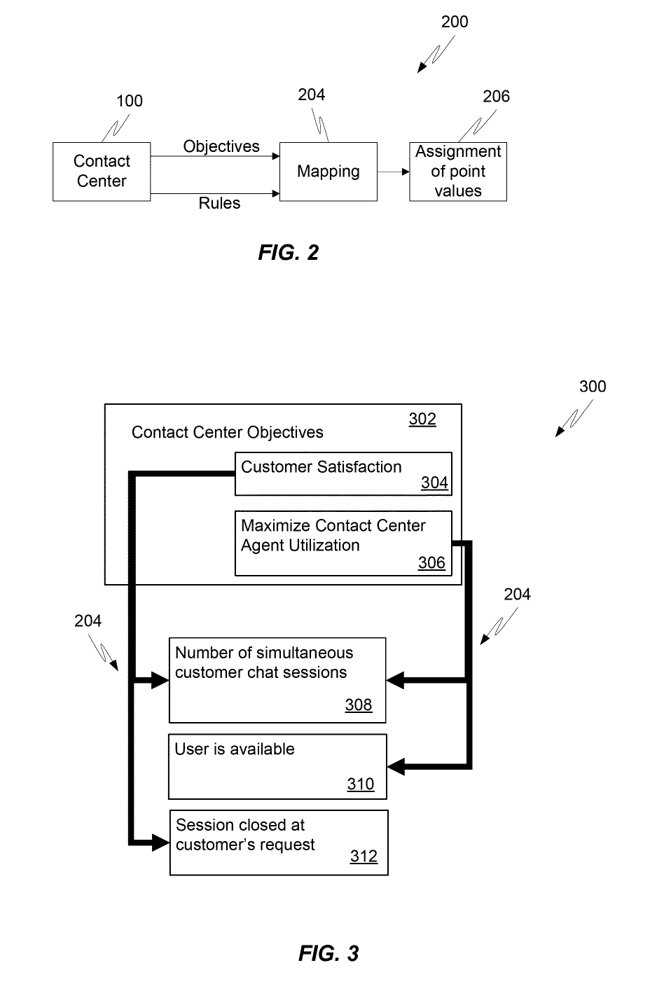

FIG. 2 illustrates high-level process 200 for the generation of rules with associated point values. Contact center 100 generates contact center objectives. Contact center 100 also provides a number of rules. The rules may be new or previously developed or a combination of both. Mapping function 204 associates rules with objectives. As a result of mapping function 204, rules are associated with objectives and assignment of point value functions 206 are associated with the rules. Contact center 100 may also develop new rules and/or objectives, modify mapping function 204 methodologies and otherwise create, delete and alter the rules with point value function 206. Mapping function 204 and/or assignment of point value function 206 may be embodied as a fully or partially automated system, such as where formula, programs, bitmap, algorithms or other methodologies are utilized whereby objective-rules mapping may be achieved. The point values assigned by point value function 206 may be a simple integer value (e.g., 100), formula (e.g., “10 points for every second under 2 minute, 25 points for every second under 1 minute”), conditional (e.g., “if completed within five minutes, 100 points”), range (e.g., “1 point for every dollar”), or other factor or combination of factors.

With respect to FIG. 3, diagram 300 is illustrated showing the mapping 204 of ones of a set of contact center objectives 302 to a number of rules 308, 310 and 312, in accordance with embodiments of the present disclosure. In the embodiment illustrated, point value factors are not provided. Contact center objectives, may be obtained from contact center objectives database 102 and mapped by mapping process 204.

Customer satisfaction objective 304 is mapped 204 to rules 308 and 312 whereby the number of simultaneous customer chat sessions and sessions closed at the customer's request are associated with rule 304. Objective 306, whereby agent utilization is a determined objective, is mapped 204 to rule 308 and 310. As a result, the number of simultaneous customer chat sessions and user availability rules 308 and 310, respectively, are associated with objective 306.

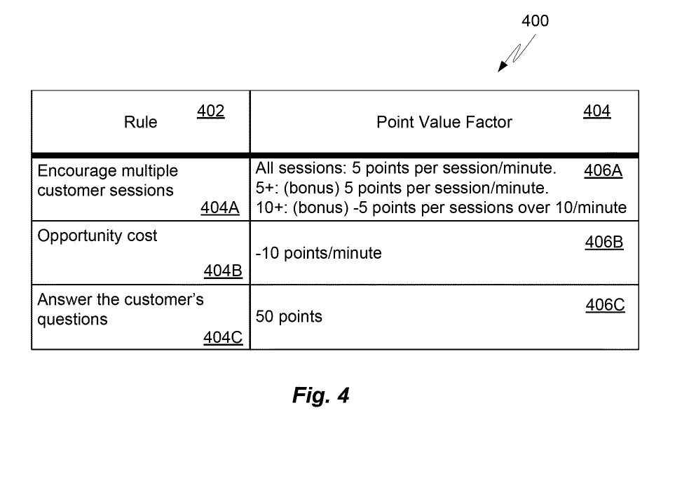

With respect to FIG. 4, table 400 is illustrated with a set of rules 302 with ones of an associated point value factor 404, in accordance with embodiments of the present disclosure. Ones of rules 404 are associated with ones of point value factors 406, such as by assignment of point values function 206. In other embodiments, one or more rules 404 are associated with single point value factor 406. The assignment of point values to rules may be accomplished by assignment of point value function 206.

Rule 404A illustrates a formula-derived point value factor where the points available to an agent depend on the performance of other tasks—in this case, the number of simultaneous session tasks. Rule 404B illustrates a time-based formula whereby the agent spends points by being “in the game” and eligible to earn points by performing other tasks. Rule 404C illustrates a simple rule whereby, upon answering the customer's question, 50 points are awarded.

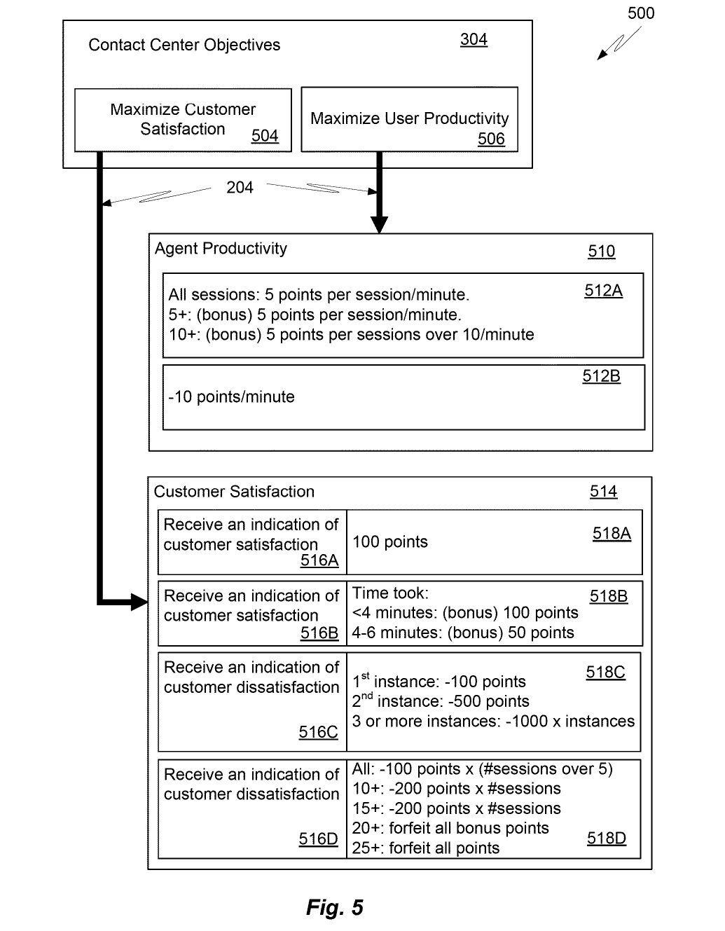

With respect to FIG. 5, diagram 500 is illustrated with a second set of contact center objectives 304 mapped 204 to rules 512 and 518 in accordance with embodiments of the present disclosure.

Diagram 500, illustrates an embodiment whereby rules 512 and 516 are categorized into categories 510 and 514, respectively. In a further embodiment, categories may form rules and have an associated point value factor. As an example, a contact center may desire to tune their objectives and weight all tasks associated with customer satisfaction category 514 higher than all tasks associated with the agent productivity category 510. In a further example, customer satisfaction category 514 has a point value of 110%, whereby any points earned by agents performing rules 516 are multiplied by 110% (or 1.1) and the agent effectively receives a 10% bonus. As a benefit, individual rules 512 and 516 may remain static while their encapsulating category 510 and 514 provides adjustment factors. In a further embodiment, such an adjustment may be negative to discourage performance of any task associated with a rule within an undesired, or less desired, category.

Customer satisfaction or dissatisfaction is determined in a variety of ways. Generally, satisfaction or dissatisfaction is with respect to the process of utilizing the contact center and not the subject matter of the contact. As an example, a customer who is dissatisfied with a product and calls a contact center to seek assistance in remedying an issue may, or may not, be satisfied with the their interaction with the contact center independently of their satisfaction with the product. In one embodiment, satisfaction may be determined by the agent receiving such an indication from the customer. In other embodiments, automated systems monitor keywords in chat sessions and emails (e.g., “can someone else help me,” “you have been very helpful,” “are you still there” and “you are not understanding”), speech recognition functions may listen for key spoken words, and voice stress analyzers may look for the customer's tone to determine the customer is frustrated or pleased. Sessions may also be monitored by another party, such as a supervisor, who may provide the indication of customer satisfaction or dissatisfaction.

Rules 512 illustrate an embodiment of the rules whereby the point value factor and the rule are the same. Rule 512A provides points for a certain number of sessions/minutes and a bonus point value, which is added to the point value upon meeting the session count criteria. Rule 512B deducts 10 points per minute. A benefit of rule 512B provides an incentive for agents to accept additional scoring opportunities, such as more tasks, higher value tasks, perform tasks well that are subject to a quality measurement task, or perform tasks quickly that are subject to a time passage penalty or promptness reward.

Although near limitless number and types of rules are provided herein, specific rule embodiments include rule 516A, whereby an indication of customer satisfaction earns an agent 100 points in accord with point value factor 518B; rule 516B whereby the same event, namely an indication of customer satisfaction, earns the agent points in accord with point value factor 518B associated with the time it took to receive the indicator of customer satisfaction. Rule 516C is a penalty rule whereby point value factor 518C is negative and escalates to become more sever in accord with the number of incidences of customer dissatisfaction. Rule 516D illustrates an embodiment whereby points may be earned for a certain behavior (see rule 512A) but if an agent is too greedy, the consequences may discourage such behavior. More specifically, rule 516D, like rule 516C, is triggered upon receiving an indication of customer dissatisfaction. Rule 516D is associated with point value factor 518D whereby the penalty point value increases with the number of sessions. As one benefit of the embodiments herein, an act may be encouraged to a point and discouraged beyond another point, thereby discouraging agents from “gaming the system” such as being idle while waiting for a high-value task. In the embodiment illustrated, the combination of rules 512A and 516D are designed to provide agents an incentive to be more productive by accepting as many customer chat sessions as they can handle without causing any of the customers to be dissatisfied.

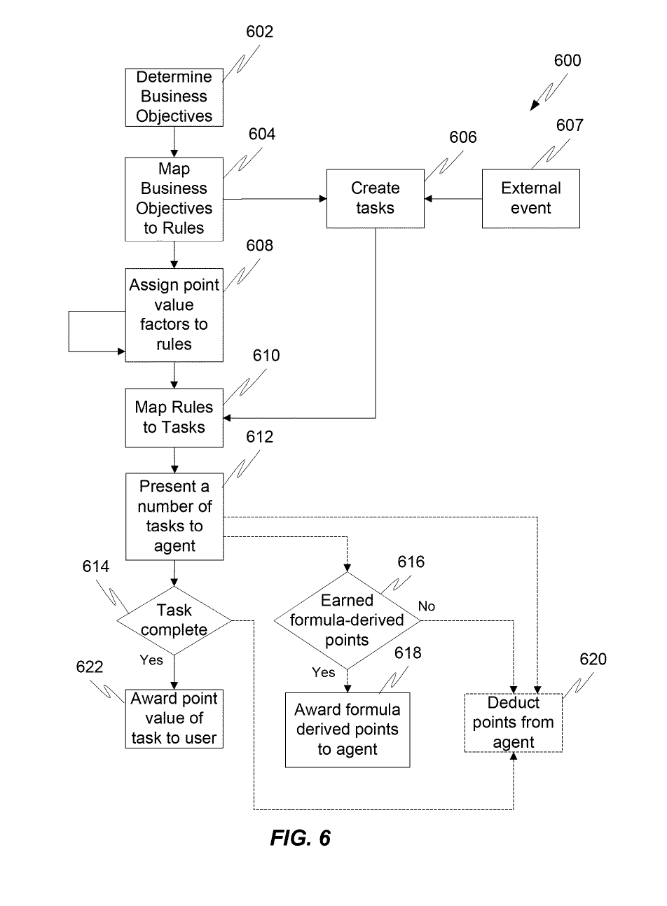

With respect to FIG. 6, flowchart 600 illustrates one method of operating a prioritization contact center in accordance with embodiments of the present disclosure. Flowchart 600 begins with step 602 determining the business objectives of the call center. Business objectives may be specific to a particular facility, customer of the contact center, or other objective the contact center wishes to pursue. While business objectives are substantially static, updated business objectives and dynamic business objectives are also contemplated.

Step 604 maps the business objectives to a number of rules. In one embodiment, a business objective may be “provide good customer service.” One rule associated with this objective may then be “answer incoming calls within 15 seconds.” Another rule may be more complex, such as, “ask the customer if they are calling about the same issue as their previous call.”

Step 608 assigns a point value factor to ones of the rules. Rules associated with a high priority business objective may be weighted with a higher point value. The point value factor of a rule may be a simple numeric value, such as, a credit of 10 points for performing a task. Point value factors may also be more complex and comprise a formula, range and may include a threshold, cap and may further include inputs from other tasks, scores or events from the agent performing the task, the agent performing a similar previous task, the performance of one or more other agents performing similar tasks, or the performance of the task in combination with one or more other tasks or events.

Step 608 may be performed a number of times and may be substantially static to highly dynamic. Contact centers may need to tune the weighing of rules to achieve the desired business objectives. As an example, if calls are being answered too quickly resulting in answered calls being placed on hold, the point value factor associated with answering the calls quickly may be assigned, by step 608, to a lower value.

Step 608 may assign, or re-assign, one or more point value factors based on predictable events, such as the time of day, day of the week, season and so on. Step 608 may assign, or re-assign, one or more point value factors based on less certain events, such as the quantity of a particular product available for sale, unusual activity within the contact center or the value of a bid received by one or more agents 120 on bidding interface 114.

Step 608 creates a task. As discussed above, tasks may be the result of a business objective, such as, “do not miss any work for six consecutive months.” Tasks are also embodied as tasks originating from external event 607. For example, external event 607 may be a customer calling a contact center or initiating a chat session which may then trigger step 606 to create, at least, the task of “accept the call” or “accept the chat session.”

Step 610 maps tasks to one or more rules. As one example, the rule “answer the call within 10 seconds and be credited 25 points” is mapped to the specific task of “answering call number 32133” and, should the agent perform the task by answering incoming call “number 32133” in ten seconds or less, the agent would be credited with 25 points (see step 620).

Step 612 presents a number of tasks to one of agents 120. The agent may actively accept the task or the task may be associated with the agent through other means. Step 612 is variously embodied. In one embodiment, tasks, such as a quality-measuring task or a task comprising a combinations of other tasks, may not be presented or, if presented, are presented in a different manner than those tasks originating from external events of step 607. Step 612 may present tasks to the agent of a particular type or other aspect the agent has request to be presented or, conversely, not presented. Step 612 may present the number of tasks as well as the rule and/or the point value factor associated with the task.

In certain embodiments, tasks are performed to completion. Task 614 determines if a task is complete. If yes, processing continues to step 622 and the agent is awarded the point value associated with the completion of the task. In other embodiments, tasks are performed to a degree. As one example, “answer an incoming call quickly” may be the task where the associated point value is a range or formula whereby points available to be earned by the agent are reduced with the passage of time. Step 616 determines if a formula-derived point value has been earned and processing then may continue to step 618, whereby the agent is credited points for formula-based performance of the task.

Optionally, step 620 deducts points from the agent. Deduction step 620 is variously embodied and may be omitted entirely. In one embodiment, after a number of tasks are presented to the agent in step 612, step 620 deducts points from the agent. In a further embodiment, step 620 deducts points from the agent for time spent being idle or less productive than expected. In such an embodiment, the agent may have accepted a task and not performed it, or may have simply not accepted a task. In other embodiments, failure to perform certain quality measurement tasks may result in step 620 deducting points. In a further embodiment, step 620 continually deducts points based on the passage of time such that the failure to earn sufficient points performing other tasks results in the agent failing to meet a threshold value. Additionally, step 620 may deduct points for not completing task in step 614 or not earning formula-derived points in step 616.

The embodiments illustrated in FIG. 6 provide one set of embodiments of a contact center. In other embodiments, the order of specific steps is rearranged without departing from the teachings herein. One such embodiment reorders steps 608, 610, and 612. In the embodiment illustrated, step 608 precedes step 610. In other embodiments, step 610 precedes step 608. In embodiments whereby the assignment, or re-assignment, of a point value factor to a rule in step 608 is triggered by a bid, it may be desirable to perform step 610 before step 608. Additional embodiments include the performance of step 612, whereby the agent is presented with tasks prior to bidding or assignment, which then results in step 608 assigning a point value to the task. In such an embodiment, step 610 may be performed prior to the performance of step 612. In such an embodiment, the agent is given the opportunity to see the task and its governing rules prior to placing a bid and triggering step 1080 to assign a point value factor to the task associated with the winning bid.

It should be appreciated that bidding to provide an assignment or reassignment of point value factors to rules 608 is variously embodied. In one embodiment, agents are presented with a task and the agent placing the highest bid at the time the bid closes wins the task. If successfully performed, the agent will be awarded points based on the points associated with the winning bid. In other embodiments, agents may place a fixed price bid and wait for tasks satisfying the fixed bid to be awarded. In such a bidding process, the bids are relatively stable with the tasks as their associated value being relatively dynamic. As an example, agent A bids 200 points for a task while agent B bids 610 points for a task. A certain task may start out with an initial value, such as zero, and be incremented until a “taker” is found. In such an embodiment, agent B would win all tasks; however, agent B must be able to accept the task. If agent B is unqualified to handle the task, such as by being too busy with other tasks, agent B may be excluded from the bidding process. As a result, the higher bid from agent A may win tasks over lower bids. Other bidding embodiments include bidding with distinct assets, such as a number of bidding points that are separate from points earned for performing tasks.

In a further embodiment, step 612 presents only those tasks to one of agents 120 that the agent has won the bid to perform. In an alternative embodiment, step 612 presents only those tasks to one of agents 120 for which the agent has an option to win. As an example, agents not qualified or not available to perform a certain task are not presented the task by step 612. As a further example, one of agents 120 may express a criterion, such as a minimum point value or type of task, in order to be shown a task by step 612.

While rules may work in concert with other rules, it should be apparent to ones of ordinary skill in the art that specific single rules dealing with combinations may produce a similar result as multiple rules working in concert, all of which are contemplated by the teachings herein.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions, to perform the methods (FPGA). These machine-executable instructions may be stored on one or more machine readable mediums, such as CD-ROMs or other types of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor or processors may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means, including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of operating a contact center, comprising:
mapping contact center objectives to a number of rules, whereby a point value is associated with ones of the rules and weighted in accord with the call center objectives;
presenting to an agent, a plurality of tasks of which at least two of the tasks conflict, the plurality of task being associated with at least one of the number of rules and further associated with the point value associated with the at least one of the rules;
presenting to the agent, the point value associated with the tasks; and
incrementing a stored value associated with the agent the point value associated with a performed task.

2. The method of claim 1, whereby at least one rule further comprises a time measurement rule and the point value associated with at least one task changes in accord with the passing of time.

3. The method of claim 1, whereby the assigning of the point value to ones of the number of tasks, further comprises, assigning a formula to determine the point value to be assigned to a task, the formula incorporating at least one variable.

4. The method of claim 1, whereby the point value is a penalty point value.

5. The method of claim 1, whereby, at least one task is a combination task, comprising, at least two other tasks and the associated point value is weighted in accord with the call center objective in the performance of the combination of the at least two other tasks.

6. The method of claim 1, further comprising, receiving from one agent, a selection of the task the one agent desires to perform thereby excluding all other agents from the opportunity to perform the task.

7. The method of claim 6, whereby:
the selection by the one agent of the task, further comprises, placing a bid, which is determined to be a winning bid; and
the point value of the task is determined by at least the winning bid.

8. A system, comprising:
a contact center operable to receive a number of contacts and associate the number of contacts with a number of agents;
a database, further comprising, a number of rules with an associated point value factor determined in accord with at least one objective of the contact center,
a means to receive a number of tasks, the tasks being associated with at least one of the number of rules;
a presentation interface to present the number of tasks to ones of the agents, such that the agent may select from the number of tasks, with at least two tasks being in conflict, a second number of tasks to be attempted; and
an accumulator to accumulate the number of point values associated with tasks performed by ones of the number of agents.

9. The system of claim 8, wherein the associated point value factor is a formula operable to determine the point value associated with a variable input value.

10. The system of claim 9, wherein the variable input value is a time value.

11. The system of claim 9, wherein the variable input value is an agent workload value.

12. The system of claim 9, wherein the variable input value is associated with the performance of a combination of at least two tasks.

13. The system of claim 9, wherein the variable input value further comprises:
a first metric associated with the performance of one of the agents; and
a second metric associated with the performance of at least one other agent.

14. The system of claim 9, wherein the variable input value further comprises:
a first metric associated with the performance of one of the agents; and
a second metric associated with the performance of the one of the agents during at least one of a) a period of time and b) a task, that is different from the first metric.

15. A non-transitory computer readable medium storing instructions that when executed on a machine cause the machine to perform:
presenting to a number of agents, a number of contact center tasks, each contact center task being associated with a rule, the rule being further associated with a point value factor in accord with an objective of a contact center;
receiving a bid point value from at least one agent associated with at the at least one contact center task;
determining the winning bidder as the agent originating the received bid point value winning the bid;
setting the point value factor of the at least one contact center task to the bid point value;
assigning the at least one contact center task to the winning bidder;
upon satisfying the at least one contact center task, crediting the winning bidder the point value factor; and
debiting a portion of number of agents a resource point value associated with the passage of time.

16. The medium of claim 15, further comprising, crediting the winning bidder a secondary point value factor associated with a secondary rule with an associated point value factor in accord with another objective of the contact center.

17. The medium of claim 16, wherein the secondary rule is a contact satisfaction rule.

18. The medium of claim 15, whereby debiting the portion of number of agents the resource point value associated with at least the time consumed while being an agent, further comprises debiting substantially all of the number of agents.

19. The medium of claim 15, whereby debiting the portion of number of agents the resource point value associated with the at least the time consumed while being an agent, comprises, debiting the portion of number of agents the resource point value associated with the at least the time consumed while being an agent and time consumed while not working at least one contact center task.

20. The medium of claim 15, further comprising, at least one bonus rule with an associated bonus point value associated with the performance of at least two other tasks.
